(19) United States
(12) Patent Application Publication
(10) Pub. No.: US 2017/0349407 A1
(43) Pub. Date: Dec. 7, 2017

(54) Elevator system, with two emergency safety brake devices and a shock-proof system

(71) Applicant: JEAN-FRANCOIS BENOIT, DRUMMONDVILLE (CA)

(72) Inventor: JEAN-FRANCOIS BENOIT, DRUMMONDVILLE (CA)

(21) Appl. No.: 15/173,684

(22) Filed: Jun. 5, 2016

(51) Int. Cl. B66B 5/26; B66B 5/28; B66B 5/02; B66B 5/12; B66B 11/02; B66B 7/02

(52) U.S. Cl. CPC B66B 5/26; B66B 11/0286; B66B 7/02; B66B 5/027; B66B 5/12; B66B 5/28

(57) ABSTRACT

An elevator system consisting in a platform steel floor fixed to four bogeys guiding the descent or ascension of the platform onto the two steel H beam or steel linear motion track profiles. The elevator is operated by a remote or pad control transmitting signals with a wire or with a wireless frequency signals to a motorised mechanical engine or electric winch at the ground level of structure, if not being manually operated and controlled. The motorised mechanical engine or electric winch unrolls one or a set of normal operation cables to allow the descent of the elevator platform and the sliding o f t he bogeys along the lateral guiding tracks. The motorised mechanical engine or electric winch rolls the set of normal operation cables to allow the ascension of the elevator platform and the sliding of the bogeys along the lateral guiding tracks. The set of operating cables drives a fixed pulley on a driving steel shaft at the top of the structure or elsewhere on the elevator system. On the driving steel shaft is also there one or many steel drums or pulleys to allow unrolling and rolling of a second independent steel cable standing for a first emergency safety brake device activated by one or many inertia brakes which stops rotation on steel shaft at excessive speed rotation of steel shaft if a fracture or breaking happens on the set of operating cables and engage the free falling of the elevator platform. The set of safety cables is attached to steel hooks fixed to the shock-proof steel plate attached underneath the elevator platform by compression springs and guided by steel rods inserting steel bushings. The shock-proof safety steel plate is retained by two fixed steel cables attached to elevator platform and to a steel hook half ring or U-Bolt mounted on the shock-proof safety steel plate.

The second emergency safety brake device is engaged when the two spur gears collides together after the compression of the springs or of any other kind of shock absorber when the set of safety cables ask to stop the free felling of the shock-proof steel plate and because the two opposite spur gears are taking two different directions onto the steel gear track or gear rack with teeth and also having then two different rotation direction; one spur gear is going down and the other spur gear is stopping its rotation. When the emergency break is applied for the elevator to stop its free falling, the safety trap on elevator floor can be lifted manually and be blocked by engaging the retainer steel arm in the corner steel angle and sided steel plate to allow the person to evacuate by the ladder bars fixed on the structure and the ladder bar underneath safety trap.

### TECHNICAL FIELD APPLICATION

This invention relates to emergency safety brake device for elevators for one person or many persons in commonly requested application for any high structure and building like silos, reservoirs, wind Aeolian structures, electric towers, radio towers and frequency signals transmission towers, any other towers and any other high structures commonly used in residential commercial, agricultural and farming, institutional, governmental and industrial activities. The elevator is usually operated and controlled with wired or wireless frequency signals from a remote or pad control to a motorised mechanical engine or electric winch, if not being manually operated and controlled. The two safety brake devices are meant to be patented to meet the requirements of the safety agencies of the states and local country and such equivalent offices of foreign countries' safety and regulation agencies and also to meet the CSA standards for operating an elevator system for individuals.

### PREVIOUS TECHNIQUES

As explained by Joe C. Pohlman in the U.S. Pat. No. 3,908,801 granted on the 30^{th} of September 1975, concerning many various previous techniques and assemblies of elevators, the two major problems encountered with all types of those elevators is the danger of sudden breaking of the power cable of the elevator and the lack of an efficient safety brake system to avoid a sudden overspeed fall of the elevator and the people inside of it and the other problem is the unsafely way for people stuck in an elevator stopped midway or very high on the structure to get out of the elevator and to reach the ladder to get down manually on the ground after.

With the invention of Mr. Pohlman, many things must be analysed very accurately in its invention to consider the danger remaining with his elevator system with hoist car, cables and brake pad shoes system engaging to appreciate more the risk of failure of his elevator system, although his system for that time was very innovative compared to more ancient invention of other elevators.

First, his invention is only relying on a few quantity of power and safety cables. On the patent drawing of Mr. Pohlman, there is one cable for the powering upward or downward of the elevator in the middle and in the front of the ladder between the ladder and the hoist car, and also two cables for the safety of the breaking emergency system. It is at first look quite good, but not enough for a total safety of the passengers. An explanation of the danger of the brake system of his invention is that the three cables are not independent from each other, somehow if the power cable brakes, then all the tension on the hoist shaft on the ground will be giving forces in the same rotation direction on the shaft, giving then for sure many Newtons more on the shaft due to the weight of the elevator and the speed of the falling elevator and therefore not having opposite forces of different cables rotating, unrolling and rolling in opposite direction on the shaft anymore. This might cause the shaft to brake or to unroll free then for the safety cables after the breaking of the power cable. Patent offices and people should note also the mistake in his invention and patent drawing as the power cable does not look to roll onto the shaft (78) on FIG. 1 but seems to go that way on FIG. # 2 as the power cable goes from pulley or shaft (74) to main hoist shaft or pulley (78). Third, his invention relies partially onto only one engaging fork touching and rubbing the powering cable to engage the emergency brake pad shoes onto the ladder tracks. If the power cable does break, nothing is sure that the fork will touch and rub long enough the broken power cable to engage the brake system, neither that the overspeed of the falling elevator and its power cable will engage the fork and the brake system that way. The power cable could easily go through the fork and not engage the brake system. Since all the pulleys are fixed inside the elevator on FIG. # 5 and on some fixed brackets, depending on the travel between those fixed pulleys, there is not a wide variance in the angles of the cable that could force the fork to rub and engage afterward and therefore to engage efficiently the brake system in case of real emergency free falling of the elevator. Also, his invention relies on some brake pad shoes rubbing the tracks of the ladder, supposed to be made out of metal to last longer and safer in case of uses of emergency brake. For sure, people know that brake pad shoes rubbing metal as for brakes on cars and trucks need to rub for a couple seconds before the mechanical engine is really stopped, this phenomenon could be called the brake deceleration delay. Nothing is sure that the brake pad shoes will have and last long enough to decelerate and then after stop the elevator, neither that the tracks of the ladder or the brake pad shoes are still in good conditions to serve well in case of emergency felling. Finally, with bis invention, Mr. Pohlman is fixing the elevator with a pair of rolling pulley both at 45 degrees facing the angle of each side of the track ladder, on both side of the ladder for a total of 4 pulleys, at least on the top of his elevator, this arrangement could cause the elevator and his metal pulleys for riding the tracks to encounter some slack of the pulleys onto many tracks upward not fixed so well in their alignment, neither that normal wear of the pulleys and brackets sustaining the pulleys could allow the elevator to disengage from the tracks of the ladder, and on top of it, the mounting tracks of the ladder should suffer very rapid wear of the riding and rubbing of the pulleys and brake pad shoes onto the tracks related to normal and additive using and operation of the elevator that might causes the brakes, tracks and ladders to become rapidly unusable and not safe at all because of constant wear, friction and rubbing from metal onto metal. Finally, but not to be forget, the falling of his elevator could hurt people inside the elevator in case of an overspeed falling before the final stopping of his elevator.

Concerning the differences between this patent application and the patent number CN202829197 of Mr. Wenyuan, the use of force friction disks onto the elevator platform described as a centrifugal governor in his patent application is somewhat different than the hereby present use of a centrifugal inertia brake engaging a locking system as sprockets, gears, solenoids, electric coils and springs but not using friction disks, on the operation shaft or on other bonded shaft to operation shaft. This present inventive application avoids the use of having to make some maintenance on a scheduled or regular basis for verifying the force friction disks once in awhile, since there are no friction disks in this present application, ensures the full efficiency of the safety breaking device and avoids a risk of failure of operation of the emergency brake system in case of the need of the emergency brake system. No drawings were available to verify the patent of Mr. Wenyuan but according to textual description and claims, the use of friction disks on the elevator car are obviously cited and seems to be forced friction disks to rub friction onto something on the fixed structure or on the shaft onto the elevator car after pushed by springs in case of an excessive speed of the overspeed centrifugal governor, still unclear about how it is activated and what happens when the system gets rid of the piece and after how it gets back the said piece which is unclear what piece it is referring to. The use of centrifugal forces is not new, it is a conceptual force that has always existed. An inertia brake differs from friction brake, inertia brake will block totally at one point of excessive speed not gradually even within few fractions of seconds with friction brake, wherein the definition of inertia and friction. Friction includes automatically the contact of two separated object moving in different or opposite directions from each others, hereby bringing the term gradual from the movement in the contact surfaces.

The same basic friction brake system concept is used with Pohlman's patent using friction brake instead of inertia brake used in this present patent application.

Legends for Parts Numerals Related to Drawings/FIGS:

A) Related to drawing/FIG. # 1: Tide of FIG. #1: Frontal view of the elevator system

```
  1-Pillow block bearing
  2-Pulley fixed on shaft
  3-Drum
  4-Inertia brake
  5-Steel shaft
  6-Mounted blocks
  7-Mounted blocks
  8-Rubber bumpers
  9-Steel H beam or steel linear motion track
profiles
10-Steel plate for bogeys
11-Rollers
12-Fixing steel plate with hooks
13-Steel gear rack (or track) with teeth
14-Steel corner brackets
15-Elevator floor
16-Spur gear attached to elevator floor
17-Steel corner brackets
18-Steel shaft
19-Spur gear attached to shock-proof steel
plate
20-Compression springs
21-Steel rod
22-Steel bushing
23-Shock-proof steel plate
24-Ladder rung fixed on elevator floor
25-Steel hook half ring
26-Steel cable clamp
27-Radio controlled winch
28-Steel cable for operation of elevator
platform
29-Radio frequency control to winch
(. . .)
37-Steel ramp bars or plates
(. . .)
39-Steel union plate for bogeys
40-Ladder bars fixed on structure
41-Steel cable or safety break
42-Steel hook half ring to attach steel cable
43-Retaining steel cable
44-Steel hooks half rings
45-Welded steel plates fixed by bolts on
structure
```

Legends for Parts Numerals Related to Drawings/FIGS:

B) Related to drawing/FIG. # 2: Title of FIG. 2: Top aerial view of the elevator platform
15 -Steel checker plate or other material for elevator floor ( . . .)
30-Steel hinges
31-Plastic retainer for steel arm
32-Steel handle
33-Steel checker plate or other material for elevator floor and safety trap
34-Steel angle with steel side plate for anchor to steel arm
35-Steel hook half ring
36-Steel arm
37-Steel ramp bars or plates
38-Steel safety ramp

### Resume of the Invention:

The major problem encountered with elevators is the need of a reliable and efficient safety brake device to avoid the free failing of the elevator in case of the fracture or breaking of the operating steel cable. The invention here designed gathers two safety brake devices and a shock-proof system to avoid the fracture or breaking of the safety steel cable in case of the free falling of the elevator platform.

The inventive purpose of this present application resides on two separated and independent emergency safety brake devices, being totally independent to the set of normal operation cables, installed on one or many safety cables totally independent from the set of normal operation cables of the elevator system and first said emergency safety brake device using one or many centrifugal inertia brakes and a shock absorber like springs or other kind of shock absorber for the first safety brake device and also a second emergency safety brake to avoid disengaging of the set of inertia brakes in case of elevator platform stepping upward while and after the shockproof system is accumulating and giving back the energy absorbed with the sudden blocking of the inertia brakes, both safety brake devices which could not be used separately to avoid accident with just, the use of one of these safety brake devices. It is a must that both safety brake devices have to be there on the present, installation and application together. First brake is requested here to stop the free falling down and the second safety brake device to avoid the upward jump of the elevator platform while and after the accumulation and release of energy by the shock absorption.

A first emergency safety brake device designed and activated by one or many centrifugal inertia brakes at the top of structure or anywhere else In the elevator system when excessive speed rotation of their steel shafts is happening, engage really quickly to stop the rotation suddenly without decelerating delay as a brake system engaging in opposite forces and locking into a special protected design but really safe and designed to support an accurate weight capacity strong enough for the designed elevator platform and the people capacity of the elevator platform. Both sets of cables, the operating cables and the safety brake device cables are totally independent from each other, then providing more reliable source of safety since only one or many bonded steel shafts is the intermediate between those two sets of cables, each set of cables that could have their own separated shaft or having the same shaft. Any breaking of all operating cables on the steel shaft would not affect the good function of the set of inertia brakes and their emergency safety cables, to engage into a blocking status and would not affect the rest of the elevator mechanism neither damage the mechanics of the elevator system. After the blocking of one or many inertia brakes, then the shock-proof system absorb the shock of a sudden stop of the safety steel cable.

Finally, a second emergency safety brake device to avoid upward jump of the elevator platform is activated while and after the sudden blocking status of the inertia brakes and shock absorber is accumulating energy. Standing here as an application of a second emergency safety brake are die two spur gears colliding and then locking the elevator on the steel gear track or gear rack with teeth. A safety trap on elevator floor can he lifted and allows the individuals to go down with the ladder bars on the structure and the ladder bar underneath the safety trap.

Another problem encountered here is the operation and control of the operating motorised mechanical engine or electric winch distant from the individuals taking place in the elevator, here resolved by the use of a wireless frequency remote or pad controlling the motorised mechanical engine or electric winch, but a traditional wired signal could still be used or also being manually controlled and operated.

### BRIEF DESCRIPTION OF DRAWINGS/FIGS.

Figures listed below are titled on top of each FIG. showed.

FIG. 1 is a frontal view of the elevator system

FIG. 2 is a top aerial view of the elevator platform

### DETAILED DESCRIPTION OF DRAWINGS WITH REFERENCES

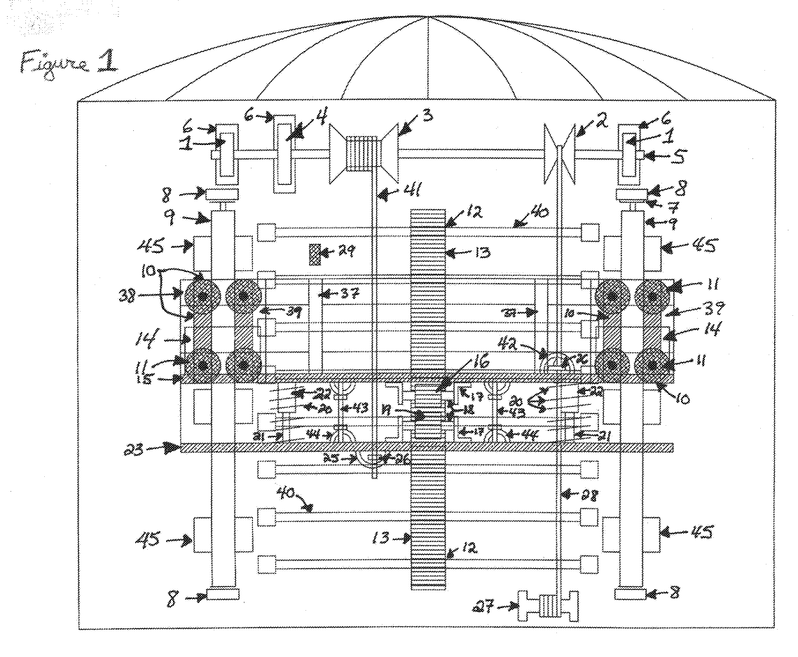

FIG. 1 is a Frontal View of the Elevator System for a High Structure,

The elevator platform floor (15) made of checker steel plate, the safety steel ramp (38) and the steel ramp bars or plates (37) are attached to four bogeys (10) with rollers (!!) or balls by steel union plates (39) and by steel corner brackets (14). The bogeys (10) slides downward or upward onto the two lateral guiding devices (9) made of steel H beams or steel linear motion track profiles fixed on the structure by welded steel plates (45) to the guiding device (9) and bolted or attached by welding to the structure. The elevator platform (15) is then operated and controlled by a wireless or wired frequency remote or pad control (29) transmitting signals for operation to the controlled motorised mechanical engine or electric winch (27) at ground level. When the motorised mechanical engine or elective winch (27) unrolls the operating steel cable (28) it allows the elevator platform (15) to go downward and when the electric winch (27) rolls the operating steel cable (28) it allows the elevator platform (15) to go upward. Rubber bumpers and/or compression springs (8) are fixed to the structure on mounted blocks (7) at ends of the guiding steel 11 beams or guiding steel linear motion track profiles (9) to stop the sliding of bogeys (10) and of the shock-proof safety steel plate (23). Fixing steel plates (12) are tightened with screws or bolts to the steel gear track or gear rack with teeth (13) and attached to ladder bars (40) by steel hooks half rings or U-Bolts (42). The operating steel cable (28) attached to the elevator steel floor (15) by a steel hook half ring or U-Bolt (42) also drives a fixed pulley (2) on driving steel shaft (5) and also drives the steel drum (3) which unrolls the same free length of the safety steel cable (41) when elevator platform (15) is going downward and rolls the same length of the safety steel cable (41) when elevator platform (15) is going upward. The operating steel driving shaft (5) at the top of the structure is allowed to rotate free inside two distant sided pillow block, bearings (1) mounted on mounted blocks (6). The use of an inertia brake (4) will stop the rotation of the operating steel shaft (5) when excessive speed rotation is happening in case of the fracture or breaking of the operating steel cable (28) and the free frilling of the elevator platform (15) demanding acceleration of the unrolling of the safety steel cable (41) on its shaft. The stop of the rotation of safety shaft, for inertia brake (5) will stop unrolling the safety steel cable (41) and then engaged the shock-proof safety steel plate (23) attached to the safety steel cable (41) by steel hook half ring (25) and by steel cable clamps (26) to stop its descent onto the steel gear track or gear rack with teeth (13) and stop the rotation of the spur gear (19) attached to steel shaft (18) and steel corner brackets (17) fixed to shock-proof safety steel plate (23). Since the elevator platform (15) will continue to go downward, the compression of any kind of shock absorber here designed as springs (20) will compress and absorb the shock and then steel rods (21) will insert the steel bushings (22) allowing the shock-proof safety steel plate (23) and the spur gear (19) attached to it to collide with the spur gear (16) attached to elevator platform (15). When the collision happens between the two spur gears (16) and (19), the system is locked on the steel gear track or gear rack with teeth (13) and the free falling of the elevator platform (15) is stopped and also avoid any upward jump of the elevator platform (15). Then, people taking place in the elevator can lift an emergency safety trap (33) in the elevator floor (15) and go down with ladder rung or ladder bar (24) underneath safety trap and then with ladder bars (40) fixed to the structure to get to the ground level safely. To retain the shock-proof safety steel plate (23) to fall down free, two retaining steel cables (43) are attached to elevator steel floor (15) and two steel hooks half ring or U-Bolts (44) fixed to the shock-proof safety steel plate and locked with steel cable clamps (26).

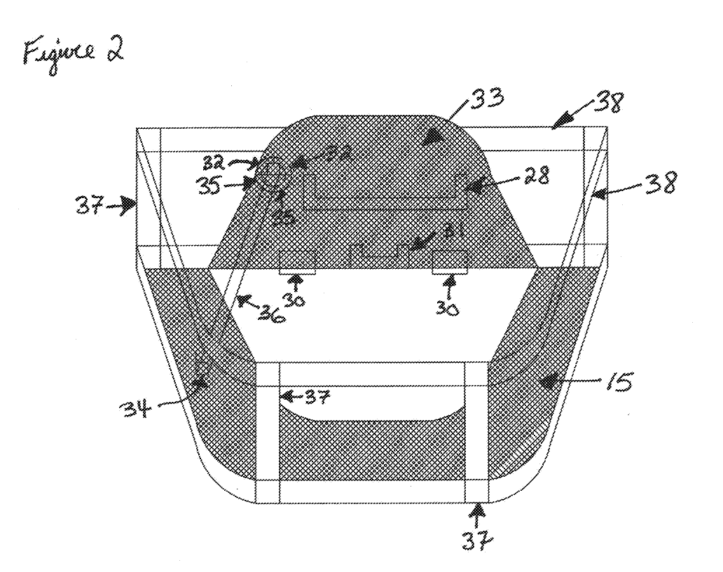

FIG. 2 is a Top Aerial View of the Elevator Platform Floor.

The main floor of the elevator (15) is made of checker steel plate. Fixed to the main floor of the elevator (15) are the steel ramp bars or plates (37) and the safety steel ramp (38). In the elevator platform floor (15) is an emergency safety trap (33) that can be lifted manually by the steel handle (32) and there is a steel arm (36) that can be released from its plastic retainer for steel arm (31) and then rotates from its fixing steel hook half ring or U-Bolt (35) to engage in the steel angle with steel side plate (34) for an anchor to steel arm (36).

1. An elevator system, having two emergency safety brake devices and a shock absorption system, totally independent to the normal operation, manually or from a motorised mechanical engine or electric winch, first said emergency safety brake device, being a centrifugal inertia brake (4) or a set of centrifugal inertia brakes, not using friction, but blocking suddenly its rotation at an excessive speed on the steel shaft (5) of the inertia brake induced or brought by an excessive unrolling speed of the emergency safety cables (41) on its shaft (5) and pulley or drum (3), in case of the free falling or malfunction of the elevator platform (15); the second emergency safety brake is designed to avoid the elevator platform (15) to get an upward jump while and after first emergency brake being applied and shock absorber accumulating or releasing the energy of the sudden blocking of first emergency safety brake, said first emergency inertia brake device engaging a locking system as sprockets, gears, solenoids, electric coils and springs but not using friction disks; the elevator system, having at least two totally independent sets of cables, made out of steel or other material, first sa id set of cables standing only for the normal operation cables (28) of the elevator system and the other said set of cables standing only for the emergency safety cables (41), made out of steel or other material; the elevator system, having a shock absorber standing for a shock -proof system for the elevator platform (15) composed of compression springs (20) or other kind of springs or by air or fluid pressure tube shock absorber to absorb the gravity force of the sudden blocking of the inertia brake and of the stop of unrolling of the safety cables, said shock absorber being on the elevator platform (15) itself or elsewhere on the elevator system; the elevator system, being operated manually or by wired or wireless frequency signals from a remote (29) or pad control to a motorised mechanical engine or electric winch (27).

2. An elevator system, as defined in claims 1, having the second emergency safety brake composed of two gears (16) (19) colliding together on their run onto the gear rack or track (13) to avoid an upward jump of the elevator platform (15) and also to avoid the inertia brake (4) to release its blocking status engaged when a shock absorber for the elevator platform is absorbing the energy of the sudden stop of the free falling of the elevator platform (15).

3. An elevator system, as defined in claim I, having lateral guiding tracks (9) using H beams or linear motion track profiles, made out of steel, aluminum, other metals, PVC (Polyvinyl Chlorate) or any other plastics or even made out of wood and having the ladder bars (40) attached or not to the lateral guiding tracks (9).

4. An elevator system, as defined in claim 2, having a gear track or gear rack with teeth (13) made out of steel, aluminum, other metals, PVC (Polyvinyl Chlorate) or any other plastics or even made out of wood.

5. An elevator system, as defined in claim 1, having an elevator platform floor (15), the safety ramp (38) and its ramp bars or plates (37) made out of steel aluminum, other metals, PVC (Polyvinyl Chlorate) or any other plastics or even made out of wood.

6. An elevator system, as defined in claim 1, having rollers (11) of the bogeys (10) and/or bogeys (10) made out of steel, aluminum, other metals, PVC (Polyvinyl Chlorate) or other plastics such as UHMW or rubber or tires or even made out of wood or out of any other element or compound.

7. An elevator system, as defined in claim 1, having ladder bars (40) and (24) made out of steel, aluminum, other metals, PVC (Polyvinyl Chlorate) or other plastics such as UHMW or even made out of wood.

8. An elevator system, as defined in claim i, having rods (21) and bushings (22) made out of steel, aluminum, other metals or PVC (Polyvinyl Chlorate) or other plastics such as UHMW or even made out of wood.

9. An elevator system, as defined in claim 1, having bumpers (8) at the end of guiding tracks, made out of rubber or any other element or compound, or having springs as compression springs or other kind of shock absorbers made out of steel or other metals or even made out of plastics of any kind, or having both bumpers (8) and springs together used in the elevator system for the ending limit movement of the elevator.
